(19) United States
(12) Patent Application Publication
(10) Pub. No.: US 2025/0174395 A1
(43) Pub. Date: May 29, 2025

(54) COIL UNIT

(71) Applicant: HONDA MOTOR CO., LTD., Tokyo (JP)

(72) Inventor: Jin Katsuya, Wako-shi (JP)

(21) Appl. No.: 18/894,417

(22) Filed: Sep. 24, 2024

(30) Foreign Application Priority Data
Nov. 29, 2023 (JP) 2023-201725

(51) Int. Cl. H01F 27/30; H02J 50/10

(52) U.S. Cl. CPC H01F 27/306; H02J 50/10

(57) ABSTRACT

A coil unit includes a coil and a magnetic resin member (a back member and an inner member). When the power transmitting side and the power receiving side face each other, the magnetic resin member is disposed behind the coil when seen from the other side. A through hole that passes therethrough in an axial direction along a central axis of the coil is formed in the plate-shaped back member. A frame-shaped wall portion (a power receiving side wall portion or a power transmitting side wall portion) of the inner member protrudes in the axial direction from a peripheral edge portion of the through hole and is disposed in an air-core region of the coil. A cover portion (a power receiving side cover portion or a power transmitting side cover portion) of the inner member opens and closes an open end of the wall portion on the protruding side.

### CROSS-REFERENCE TO RELATED APPLICATION

Priority is claimed on Japanese Patent Application No. 2023-201725, filed Nov. 29, 2023, the content of which is incorporated herein by reference.

### BACKGROUND OF THE INVENTION

### Field of the Invention

The present invention relates to a coil unit.

### Description of Related Art

In recent years, research and development has been conducted into charging and supplying power to vehicles equipped with secondary batteries that contribute to energy efficiency, in order to ensure that more people have access to affordable, reliable, sustainable and advanced energy.

Conventionally, in a contactless power transmission system that supplies electric power from the outside of a vehicle to the vehicle by contactless power transmission, a coil device that includes a coil and magnetic flux conductive materials that are disposed inside and on a rear side of the coil is known (refer to, for example, Patent Document 1).

[Patent Document 1] Japanese Unexamined Patent Application, First Publication No. 2015-15452

### SUMMARY OF THE INVENTION

In technology related to charging and supplying power to vehicles equipped with secondary batteries, in the contactless power transmission, it is desirable to reduce a magnetic flux (a leakage magnetic flux) other than a main magnetic flux and to improve a coupling coefficient while ensuring desired ease of maintenance and robustness in each unit on the power transmitting and receiving sides. For example, as in the above-described conventional coil device, a problem arises in that when the magnetic flux conductive material is merely formed of a core portion and a flat portion made of a magnetic material and a resin, it is not possible to improve both the ease of maintenance and the robustness, and it is not possible to improve the coupling coefficient while ensuring versatility in each unit.

An aspect of the present invention has been made in consideration of such circumstances, and an object thereof is to provide a coil unit that can improve a coupling coefficient while ensuring ease of maintenance and robustness in each unit on the transmitting and receiving sides of contactless power transmission, thereby contributing to energy efficiency.

In order to solve the above problems and achieve the above object, the present invention employs the following aspects.
(1): A coil unit according to an aspect of the present invention includes a coil configured to transmit or receive electric power through contactless power transmission, and a magnetic resin member disposed behind the coil when seen from the other side when a power transmitting side and a power receiving side face each other, wherein the magnetic resin member includes a plate-shaped support portion having a hole that passes therethrough in an axial direction along a central axis of the coil, a frame-shaped wall portion that protrudes in the axial direction from a peripheral edge of the hole and disposed in an air-core region of the coil, and a cover portion that opens and closes an open end of the wall portion on a protruding side.
(2): In the aspect (1), a contact surface between the wall portion and the cover portion may be a curved surface in which a position in a direction perpendicular to the axial direction gradually changes as a position in the axial direction gradually changes.
(3): In the aspect (1) or (2), a contact surface between the wall portion and the support portion may be an inclined surface inclined at a predetermined angle with respect to the axial direction.

According to the aspect (1), by providing the magnetic resin member disposed behind the coil, for example, robustness can be ensured compared to a case in which a magnetic member such as a ferrite core is provided. For example, it is possible to curb an increase in eddy current loss due to breakage or defects, and occurrence of ground faults and short circuits due to breakdown of an insulation layer through debris.

Since the magnetic resin member includes the wall portion and the cover portion that are inserted into the air-core region of the coil, the distribution of the main magnetic flux between the power transmitting side and the power receiving side can be spread at a center portion in the direction perpendicular to the axial direction, and a core constant of the entire system can be improved. By improving the core constant, the main magnetic flux can be concentrated in the center portion, an increase in magnetic flux density on the outer side in the direction perpendicular to the axial direction can be curbed, and thus a coupling coefficient can be improved.

By providing the cover portion that opens and closes the open end of the wall portion on the protruding side, a hollow region formed by the wall portion can be easily exposed to the outside, and thus it is possible to improve ease of various maintenance operations, for example, for various devices and components disposed in an internal space communicating with the hollow region.

According to the aspect (2), since the contact surfaces between the wall portion and the cover portion are curved surfaces, it is possible to curb misalignment caused by vibrations, or the like, and to curb a change in dielectric constant and deterioration of coil performance due to inflow of water, or the like. This can curb the cover portion getting caught when it is opened or closed, and can improve load-bearing capacity and durability.

According to the aspect (3), since the contact surfaces between the wall portion and the support portion are inclined surfaces, the wall portion is able to fit into the peripheral edge of the hole in the support portion to ensure magnetic contact and to curb an increase in magnetic resistance.

### BRIEF DESCRIPTION OF THE DRAWINGS

FIG. 1 is an exploded perspective view showing a configuration of a coil unit according to an embodiment of the present invention.

FIG. 2 is a cross-sectional view of the coil unit according to the embodiment of the present invention, taken along a Z-X plane at a position of line A-A shown in FIG. 1, with a magnetic resin member omitted.

FIG. 3 is a diagram showing a configuration of a power transmitting side unit including the coil unit according to the embodiment of the present invention.

FIG. 4 is a cross-sectional view showing the magnetic resin member of a coil unit on the power receiving side according to the embodiment of the present invention.

FIG. 5 is a cross-sectional view showing the magnetic resin member of a coil unit on the power transmitting side according to the embodiment of the present invention.

### DETAILED DESCRIPTION OF THE INVENTION

Hereinafter, a coil unit according to an embodiment of the present invention will be described with reference to the accompanying drawings.

The coil unit 10 of the embodiment constitutes, for example, at least one of a power transmitting device and a power receiving device of a contactless power transmission system that supplies electric power from the outside of a moving body such as a vehicle to the moving body by contactless power transmission. The vehicle is, for example, an electrically powered vehicle such as an electric vehicle, a hybrid vehicle, or a fuel cell vehicle.

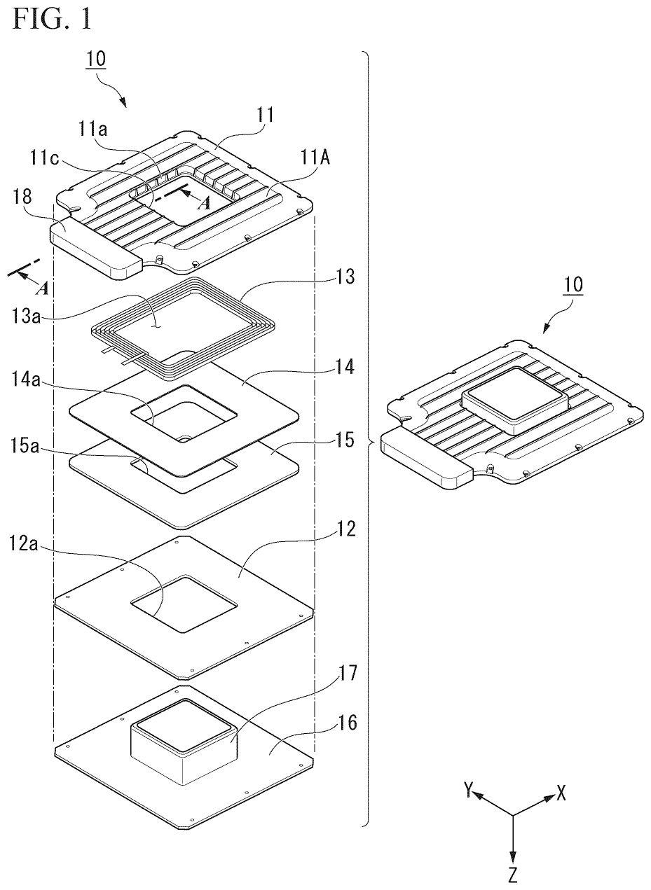

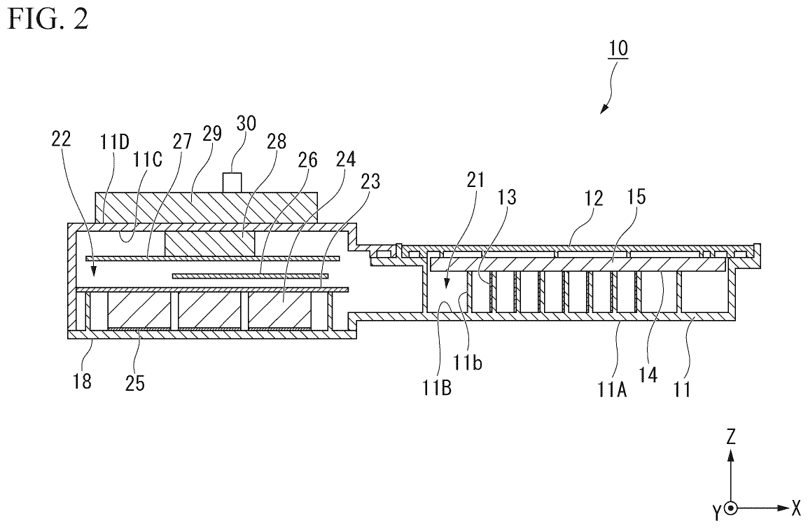

FIG. 1 is an exploded perspective view of a coil unit 10 according to an embodiment with a second cover 18 omitted. FIG. 2 is a cross-sectional view of the coil unit 10 according to the embodiment, taken along a Z-X plane at a position of line A-A shown in FIG. 1 with magnetic resin members (a back member 16 and an inner member 17) omitted.

In the following description, axial directions of an X-axis, a Y-axis, and a Z-axis which are mutually perpendicular in a three-dimensional space are directions parallel to each of the axes. For example, as shown in FIGS. 1 and 2, a Z-axis direction is parallel to an up-down direction of the moving body such as a vehicle in which the coil unit 10 is mounted, an X-axis direction is parallel to a front-rear direction of the moving body, and a Y-axis direction is parallel to a left-right direction of the moving body. For example, a positive direction of the Z axis is an upward direction of the moving body, a positive direction of the X axis is a forward direction of the moving body, and a positive direction of the Y axis is a rightward direction of the moving body.

The coil unit 10 of the embodiment shown in FIGS. 1 and 2 constitutes, for example, a part of the power receiving device mounted in the moving object.

The coil unit 10 includes, for example, a housing 11, a first cover 12, a coil 13, an insulating member 14, a core member 15, a back member 16, an inner member 17, and a second cover 18.

The housing 11 is formed to have, for example, a rectangular frame shape. The housing 11 is made of, for example, a material such as a resin having a predetermined thermal conductivity. The housing 11 includes, for example, a first accommodation portion 21 and a second accommodation portion 22. The coil 13, the insulating member 14, and the core member 15 which will be described below are disposed in the first accommodation portion 21. Each of boards 23, 26, and 27, a capacitor 24, and a semiconductor element 28 which will be described below are disposed in the second accommodation portion 22. The first accommodation portion 21 is provided, for example, to surround a lower side in the up-down direction and inner and outer sides in a direction perpendicular to the up-down direction of the coil 13, the insulating member 14, and the core member 15 which will be described below. The second accommodation portion 22 is provided, for example, behind the first accommodation portion 21 in the front-rear direction. The second accommodation portion 22 is provided, for example, to surround the upper side in the up-down direction and the outer side in the direction perpendicular to the up-down direction of each of the boards 23, 26, and 27, the capacitor 24, and the semiconductor element 28 which will be described below.

The housing 11 has, for example, a first surface 11A on which a plurality of grooves 11a are formed in the first accommodation portion 21. The first surface 11A of the housing 11 (that is, a lower surface which is a surface on the lower side in the up-down direction) is exposed to the outside below the moving body. The plurality of grooves 11a are formed in a flow direction of wind (wind caused by running, or the like) received when the moving body is moving, for example, in the front-rear direction.

The housing 11 includes, for example, a plurality of heat dissipation members 11b that protrude inward from a first inner surface 11B on the rear side of the first surface 11A. The heat dissipation members 11b are formed to have, for example, a plate-like fin shape. The plurality of heat dissipation members 11b are in contact with the coil 13.

The first cover 12 is formed to have, for example, a rectangular plate shape with through holes 12a formed in a thickness direction. The first cover 12 is provided to surround, for example, the upper side in the up-down direction of the coil 13, the insulating member 14, and the core member 15 which will be described below. The first cover 12 forms an accommodation space between the first cover 12 and a first inner surface 11B of the housing 11, in which the coil 13, the insulating member 14, and the core member 15 are accommodated. The first cover 12 closes an open end of the first accommodation portion 21 of the housing 11 in which the coil 13, the insulating member 14, and the core member 15 are accommodated.

The coil 13 is formed to have, for example, a rectangular spiral shape along the first inner surface 11B of the housing 11. The coil 13 is disposed, for example, above the first inner surface 11B. An element wire of the coil 13 is in direct contact with the plurality of heat dissipation members 11b.

The insulating member 14 is formed to have, for example, a rectangular sheet shape with a through hole 14a formed in the thickness direction. The insulating member 14 is made of an electrically insulating material. The insulating member 14 is disposed above the coil 13, for example.

The core member 15 is formed to have, for example, a rectangular plate with a through hole 15a formed in the thickness direction. The core member 15 is made of, for example, a magnetic resin material having a relatively high magnetic permeability. The core member 15 is disposed, for example, above the insulating member 14.

The back member 16 is formed to have, for example, a rectangular plate shape with a through hole formed in the thickness direction. The inner member 17 is formed to have, for example, a box shape that closes an opening of the through hole of the back member 16. The back member 16 and the inner member 17 are integrally formed of, for example, a magnetic resin material having a relatively high magnetic permeability. The back member 16 and the inner member 17 will be described below in detail.

The second cover 18 is formed to have, for example, a rectangular plate shape. The second cover 18 is provided to surround, for example, the lower side in the up-down direction of each of the boards 23, 26, and 27, the capacitor 24, and the semiconductor element 28 which will be described below. The second cover 18 forms an accommodation space between the second cover 18 and the second inner surface 11C of the second accommodation portion 22 of the housing 11, in which the boards 23, 26, and 27, the capacitor 24 and the semiconductor element 28 are accommodated. The second cover 18 closes an open end of the second accommodation portion 22 of the housing 11 in which the boards 23, 26, and 27, the capacitor 24 and the semiconductor element 28 are accommodated.

The capacitor board 23 has a plurality of capacitors 24, such as film capacitors, fixed thereto. The capacitors 24 are, for example, resonance capacitors (condensers) connected to the coil 13. The plurality of capacitors 24 are fixed to the capacitor board 23 and are in contact with the inner surface of the second cover 18 via a thermally conductive material 25 such as a thermal compound.

The control board 26 is disposed, for example, above the capacitor board 23. The control board 26 controls, for example, power conversion of the power receiving device and communication with an external power transmitting device. The control board 26 is a software functional unit that functions when a predetermined program is executed by a processor such as a central processing unit (CPU). The software functional unit is an electronic control unit (ECU) that includes a processor such as a CPU, a read only memory (ROM) that stores programs, a random access memory (RAM) that temporarily stores data, and electronic circuits such as a timer. At least a part of the control board 26 may be an integrated circuit such as a large scale integration (LSI).

The control board 26 generates a control signal to be input to a gate drive board 27 in accordance with, for example, a target output of the power receiving device. The control signal is, for example, a signal that indicates a timing of turning on (allowing conduction therethrough)/off (blocking) a plurality of switching elements that constitute a power conversion unit of the power receiving device. For example, the control signal is a pulse-width modulated signal, or the like.

The gate drive board 27 is disposed, for example, above the control board 26. The gate drive board 27 is connected to gates of the plurality of switching elements that constitute a power conversion unit of the power receiving device. The gate drive board 27 includes, for example, an integrated circuit, a plurality of gate resistors, and the like.

The gate drive board 27 generates a gate signal for actually driving each of the switching elements to be turned on (allowed to conduct)/off (blocked) on the basis of the control signal received from the control board 26. For example, the gate drive board 27 performs amplification and level shifting of the control signal to generate a gate signal.

The semiconductor element 28 is, for example, a switching element and a rectifier element that constitute a power conversion unit of the power receiving device. The switching element is, for example, a transistor such as a metal oxide semiconductor field effect transistor (MOSFET) made of silicon carbide (SiC). The rectifier element is, for example, a reflux diode connected in parallel to each of the transistors. A plurality of semiconductor elements 28 are, for example, fixed to the upper portion of the gate drive board 27 and are disposed between the gate drive board 27 and the second inner surface 11C of the housing 11.

The housing 11 includes a radiator 29 disposed on an outer surface (a second surface) 11D opposite to the second inner surface 11C. The radiator 29 is, for example, a heat sink including a plurality of fin members protruding to the outside.

The housing 11 includes, for example, a DC connector 30 that is connected to the power conversion unit of the power receiving device and protrudes externally (upward) from the second surface 11D.

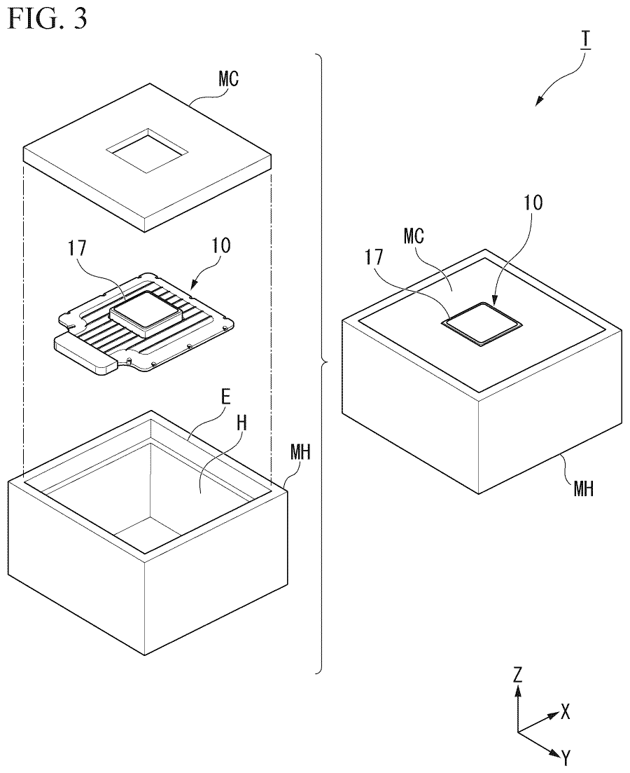

FIG. 3 is a diagram showing a configuration of a power transmitting side unit T including the coil unit 10 of the embodiment. The coil unit 10 of the embodiment shown in FIG. 3 constitutes a part of a power transmitting device installed, for example, on a road on which a vehicle runs, or the like.

The coil unit 10 shown in FIG. 3 is fixed to a cover MC of a square cylindrical manhole MH buried underground, for example, beneath a road on which a vehicle runs, or the like. The coil unit 10 is suspended from a lower surface (a rear surface) of the cover MC by, for example, an appropriate fastening member or elastic member. The cover MC of the manhole MH is made of, for example, a resin material, a fiber material, or the like. The cover MC closes an upper open end E of the manhole MH. An internal space H of the manhole MH accommodates, for example, various devices and members constituting the power transmitting device of the contactless power transmission system.

The coil unit 10 shown in FIG. 3 is fixed to the lower surface (the rear surface) of the cover MC of the manhole MH, and is thus removed from the internal space H of the manhole MH when the cover MC is separated from the upper open end E of the manhole MH. When the internal space of the manhole MH is opened to the outside by separating the cover MC, the various devices, components, and the like accommodated in the internal space H of the manhole MH are exposed to the outside.

The box-shaped inner member 17 of the coil unit 10 shown in FIG. 3 is inserted, for example, into a through hole in the thickness direction of the cover MC of the manhole MH. A part of an upper surface of the inner member 17 is exposed to the outside from, for example, the surface of the cover MC of the manhole MH, and forms the same plane as a surface of the cover MC and a road surface such as a running road.

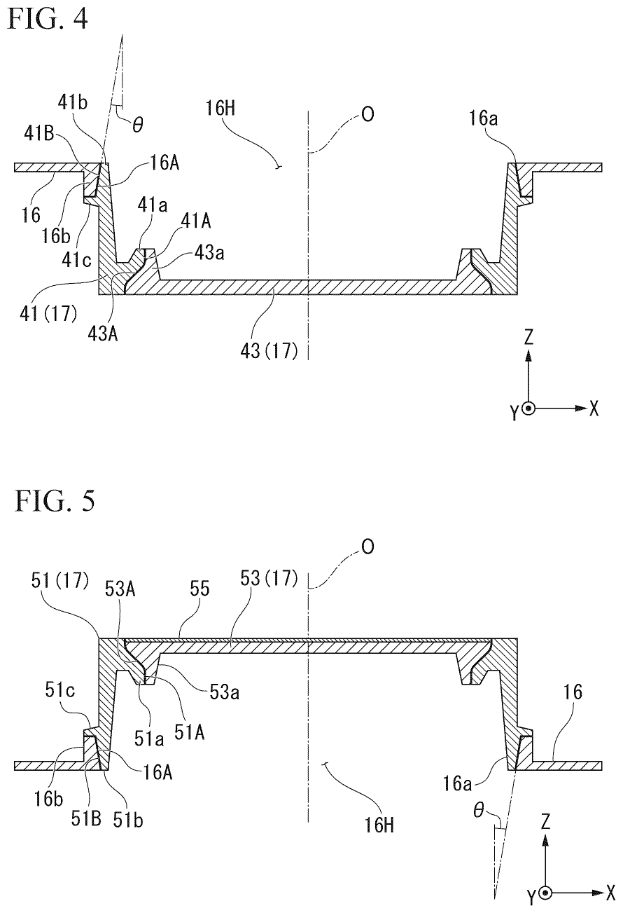

FIG. 4 is a cross-sectional view showing the magnetic resin members (the back member 16 and the inner member 17) of the coil unit 10 on the power receiving side in the embodiment. FIG. 5 is a cross-sectional view showing the magnetic resin members (the back member 16 and the inner member 17) of the coil unit 10 on the power transmitting side in the embodiment. As shown in FIGS. 4 and 5, the magnetic resin members of the coil unit 10 (that is, the back member 16 and the inner member 17) are disposed, for example, behind the coil 13 when seen from the other side when the power transmitting side and the power receiving side face each other. For example, the magnetic resin members on the power receiving side (the back member 16 and the inner member 17) are disposed behind the coil 13 on the power receiving side when seen from the power transmitting side, and the magnetic resin members on the power transmitting side (the back member 16 and the inner member 17) are disposed behind the coil 13 on the power transmitting side when seen from the power receiving side.

As shown in FIGS. 4 and 5, the back member 16 is, for example, a plate-shaped member having a through hole 16H formed therein, which passes therethrough in an axial direction along a central axis O of the coil 13. The back member 16 has, for example, a protruding portion 16b that protrudes in the axial direction from a peripheral edge portion 16a of the through hole 16H and supports the inner member 17. The protruding portion 16b protrudes toward the opposite side of the power transmitting side and the power receiving side facing each other in the axial direction, for example. Of two surfaces of the protruding portion 16b in a direction perpendicular to the axial direction, an inner surface 16A on the through hole 16H side (that is, the inner side) is, for example, an inclined surface inclined at a predetermined angle θ with respect to the axial direction. On the inner surface 16A, for example, a position in the direction perpendicular to the axial direction gradually changes outward (that is, toward the opposite side of the through hole 16H) as it goes from a base end side (a proximal end side) toward a tip end side (a distal end side) in a protruding direction along the axial direction.

The inner member 17 is, for example, a box-shaped member that protrudes from the peripheral edge portion 16a of the through hole 16H of the back member 16 in the axial direction. The inner member 17 includes, for example, a frame-shaped wall portion that protrudes from the peripheral edge portion 16a and is disposed in an air-core region 13a of the coil 13, and a flat plate-shaped cover portion that opens and closes an open end of the wall portion on the protruding side. For example, the inner member 17 on the power receiving side includes a power receiving side wall portion 41 and a power receiving side cover portion 43. For example, the inner member 17 on the power transmitting side includes a power transmitting side wall portion 51 and a power transmitting side cover portion 53. For example, outer shapes of the power receiving side wall portion 41 and the power transmitting side wall portion 51 have different lengths in the axial direction, and shapes of both end portions in the axial direction that are in contact with the back member 16 and each of the cover portions 43 and 53 are the same. For example, a length in the axial direction of the power receiving side wall portion 41 is set according to a thickness or the like of the coil 13 in the axial direction. For example, a length in the axial direction of the power transmitting side wall portion 51 is set according to a thickness or the like of a paving material, such as concrete or asphalt, to which the power transmitting side unit T is fixed on a road on which a vehicle runs, or the like. For example, outer shapes of the power receiving side cover portion 43 and the power transmitting side cover portion 53 have different thicknesses in the axial direction, and shapes of the outer edge portions in contact with each of the wall portions 41 and 51 are substantially the same. For example, the thickness in the axial direction of the power receiving side cover portion 43 is a thickness obtained by adding a thickness in the axial direction of the power transmitting side cover portion 53 and a thickness of a surface layer member 55 which will be described below.

The wall portions 41 and 51 respectively have, for example, cover support portions 41a and 51a that are in contact with the cover portions 43 and 53 at the tip end side (the distal end side) in the protruding direction, and first connection portions 41b and 51b and second connection portions 41c and 51c that are in contact with the protruding portion 16b of each of the back members 16 at the base end side (the proximal end side) in the protruding direction.

Each of the cover support portions 41a and 51a protrudes inward in the direction perpendicular to the axial direction from a tip end portion of each of the wall portions 41 and 51 in the protruding direction. Each of the cover support portions 41a and 51a forms, for example, an open end of each of the wall portions 41 and 51 on the protruding side. The inner surfaces 41A and 51A of the cover support portions 41a and 51a in contact with the cover portions 43 and 53 are, for example, curved surfaces. A cross-sectional shape of each of the inner surfaces 41A and 51A (for example, a cross-sectional shape obtained by cutting each of the wall portions 41 and 51 along a plane parallel to the central axis O) is, for example, S-shaped. For example, in each of the inner surfaces 41A and 51A, a position in the direction perpendicular to the axial direction gradually changes inward as it goes from the tip end side (the distal end side) toward the base end side (the proximal end side) in the protruding direction of each of the wall portions 41 and 51.

Each of the first connection portions 41b and 51b is, for example, a base end portion in the protruding direction of each of the wall portions 41 and 51. Outer surfaces 41B and 51B of the first connection portions 41b and 51b in contact with the inner surface 16A of each of the protruding portions 16b are, for example, inclined surfaces inclined at a predetermined angle θ with respect to the axial direction. In each of the outer surfaces 41B and 51B, for example, a position in the direction perpendicular to the axial direction gradually changes outward as it goes from the base end side (the proximal end side) toward the tip end side (the distal end side) in the protruding direction of each of the wall portions 41 and 51.

Each of the second connection portions 41c and 51c protrudes outward in the direction perpendicular to the axial direction at a position shifted from the base end (the proximal end) of each of the first connection portions 41b and 51b in the axial direction. Each of the second connection portions 41c and 51c is in contact with the tip end of each of the protruding portions 16b on the protruding side, for example.

The cover portions 43 and 53 respectively include, for example, connection portions 43a and 53a that are in contact with the cover support portion 41a and 51a of the wall portions 41 and 51. Each of the connection portions 43a and 53a is, for example, an outer edge portion of each of the cover portions 43 and 53 in the direction perpendicular to the axial direction. A part of each of the connection portions 43a and 53a protrudes, for example, from a flat portion of each of the cover portions 43 and 53 toward the base end side (the proximal end side) of each of the wall portions 41 and 51 in the axial direction. The outer surfaces 43A and 53A of the connection portions 43a and 53a that are in contact with the inner surfaces 41A and 51A of the cover support portions 41a and 51a of the wall portions 41 and 51 are, for example, curved surfaces. A cross-sectional shape of each of the outer surfaces 43A and 53A (for example, a cross-sectional shape obtained by cutting each of the cover portions 43 and 53 along a plane parallel to the central axis O) is, for example, S-shaped. In each of the outer surfaces 43A and 53A, for example, a position in the direction perpendicular to the axial direction gradually changes inward as it goes from the tip end side (the distal end side) to the base end side (the proximal end side) in the protruding direction of each of the wall portions 41 and 51.

The power receiving side cover portion 43 of the inner member 17 on the power receiving side is formed with a slit that passes therethrough in the axial direction for, for example, drainage purposes.

The inner member 17 on the power transmitting side includes, for example, the surface layer member 55 disposed to be laminated on the surface of the power transmitting side cover portion 53, that is, the surface of the tip end side (the distal end side) in the protruding direction of the power transmitting side wall portion 51. The surface layer member 55 is formed of a resin material, such as polycarbonate, that has relatively high frictional properties compared to the power transmitting side cover portion 53.

As described above, according to the coil unit 10 of the embodiment, robustness can be ensured by providing the magnetic resin members (the back member 16 and the inner member 17) disposed behind the coil 13, compared to a case in which a magnetic member such as a ferrite core is provided. For example, it is possible to curb an increase in eddy current loss due to breakage or defects, and occurrence of ground faults and short circuits due to breakdown of an insulation layer through debris.

By providing the inner member 17 that is inserted into the air-core region 13a of the coil 13, the distribution of the main magnetic flux between the power transmitting side and the power receiving side can be spread at the center portion in the direction perpendicular to the axial direction, and thus the core constant of the entire system can be improved. By improving the core constant, the main magnetic flux can be concentrated in the center portion, an increase in the magnetic flux density on the outer side in the direction perpendicular to the axial direction can be curbed, and thus the coupling coefficient can be improved.

By providing a cover portion (the power receiving side cover portion 43, the power transmitting side cover portion 53) that opens and closes the open end of the wall portion (the power receiving side wall portion 41, the power transmitting side wall portion 51) on the protruding side, a hollow region formed by the wall portion can be easily exposed to the outside. For example, it is possible to improve the ease of various maintenance operations for various devices and components disposed in the internal space communicating with the hollow region.

Since the contact surfaces (the inner surfaces 41A and 51A, the outer surfaces 43A and 53A) between the wall portion and the cover portion are curved surfaces, it is possible to curb misalignment caused by vibration, or the like, and to curb a change in dielectric constant and deterioration of coil performance due to inflow of water, or the like. This can curb the cover portion getting caught when it is opened or closed, and can improve load-bearing capacity and durability.

Since the contact surfaces (the inner surface 16A, the outer surfaces 41B and 51B) of the wall portion (the power receiving side wall portion 41, the power transmitting side wall portion 51) and the back member 16 are inclined surfaces, the wall portion can be allowed to fit into the peripheral edge portion 16a of the through hole 16H of the back member 16 to ensure magnetic contact and to curb an increase in magnetic resistance.

### Modified Example

In the above-described embodiment, although the cross-sectional shape of each of the inner surfaces 41A and 51A and each of the outer surfaces 43A and 53A is S-shaped, the shape is not limited thereto and may be a curved surface of another shape, such as a concave curved surface or a convex curved surface.

The embodiments of the present invention are presented as examples and are not intended to limit the scope of the invention. The embodiments can be implemented in various other forms, and various omissions, substitutions, and modifications can be made without departing from the spirit of the invention. The embodiments and variations thereof are included in the scope of the invention and equivalents thereof as described in the claims, as well as in the scope and spirit of the invention.

What is claimed is:

1. A coil unit comprising:
a coil configured to transmit or receive electric power through contactless power transmission; and
a magnetic resin member disposed behind the coil when seen from the other side when a power transmitting side and a power receiving side face each other,
wherein the magnetic resin member includes a plate-shaped support portion having a hole that passes therethrough in an axial direction along a central axis of the coil, a frame-shaped wall portion that protrudes in the axial direction from a peripheral edge of the hole and disposed in an air-core region of the coil, and a cover portion that opens and closes an open end of the wall portion on a protruding side.

2. The coil unit according to claim 1, wherein a contact surface between the wall portion and the cover portion is a curved surface in which a position in a direction perpendicular to the axial direction gradually changes as a position in the axial direction gradually changes.

3. The coil unit according to claim 1, wherein a contact surface between the wall portion and the support portion is an inclined surface inclined at a predetermined angle with respect to the axial direction.
